(19) United States
(12) Patent Application Publication
(10) Pub. No.: US 2023/0345964 A1
(43) Pub. Date: Nov. 2, 2023

(54) GRAPE JUICE-CONTAINING GUMMY CONTAINING POLYUNSATURATED FATTY ACID

(71) Applicant: FUJI OIL HOLDINGS INC., Osaka (JP)

(72) Inventor: Miwako MORIKAWA, Osaka (JP)

(73) Assignee: FUJI OIL HOLDINGS INC., Osaka (JP)

(21) Appl. No.: 17/922,377

(22) PCT Filed: Apr. 7, 2021
(86) PCT No.: PCT/JP2021/014699

§ 371 Date: Oct. 31, 2022

(30) Foreign Application Priority Data
May 15, 2020 (JP) 2020-085595

(51) Int. Cl. A23G 3/40; A23G 3/48

(52) U.S. Cl. CPC A23G 3/40; A23G 3/48

(57) ABSTRACT

The present invention addresses the issue of providing a grape juice-containing gummy that contains polyunsaturated fatty acid and has reduced occurrence of offensive odors derived from the polyunsaturated fatty acid. The present invention provides a grape juice-containing gummy containing polyunsaturated fatty acids obtained by forming an oil and fat composition in which a water phase with a particle diameter of 300 nm or less in which a polyphenol as water-soluble antioxidants and an organic acid are dissolved is finely dispersed in an oil phase containing polyunsaturated fatty acids and dispersing the oil and fat composition in a gummy containing grape juice, thereby suppressing the occurrence of unusual flavor in the gummy.

### TECHNICAL FIELD

The present invention relates to reducing the occurrence of offensive odors in a grape juice-containing gummy containing polyunsaturated fatty acids.

### BACKGROUND ART

Patent Literature 1 discloses a gummy containing DHA and EPA. Here, gummies containing polyunsaturated fatty acids will be described.

### CITATION LIST

### Patent Literature

### Patent Literature 1

Japanese Patent Laid-Open No. 2018-46788

### SUMMARY OF INVENTION

### Technical Problem

An objective of the present invention is to provide a grape juice-containing gummy containing polyunsaturated fatty acids in which the occurrence of offensive odors derived from the polyunsaturated fatty acids is reduced.

### Solution to Problem

The inventors first examined incorporation of polyunsaturated fatty acids into gummies. Here, it was found that there was a difference in occurrence of unusual flavors derived from polyunsaturated fatty acids depending on the type of fruit juice used for gummies. That is, in gummies using citrus juice, the occurrence of unusual flavors could be reduced by using vitamin C that is generally used as an antioxidant, but this effect was limited in grape juice-containing gummies. Therefore, a new task of reducing the occurrence of unusual flavors over time when polyunsaturated fatty acids are incorporated into grape juice-containing gummies was found.

In Patent Literature 1, although “fruit juice” is mentioned at a certain point, there is no mention of grape juice, and it is described as an optional component in the first place, and its effect and the like are not suggested.

The inventors conducted additional examinations, and found that, by forming an oil and fat composition in which a water phase with a particle diameter of 300 nm or less in which a polyphenol as a water-soluble antioxidant and an organic acid are dissolved is finely dispersed in an oil phase containing polyunsaturated fatty acids, and dispersing the oil and fat composition in a grape juice-containing gummy, the occurrence of unusual flavors in the gummy can be reduced, and completed the present invention.

Specifically, the present invention relates to:
(1) A grape juice-containing gummy containing polyunsaturated fatty acids obtained by forming an oil and fat composition in which a water phase with a particle diameter of 300 nm or less in which a polyphenol and an organic acid are dissolved is finely dispersed in an oil phase containing polyunsaturated fatty acids and dispersing the oil and fat composition in a gummy containing grape juice.
(2) The grape juice-containing gummy containing polyunsaturated fatty acids according to (1), wherein the amount of the polyunsaturated fatty acids in the gummy is 0.1 to 1.2 mass %.
(3) The grape juice-containing gummy containing polyunsaturated fatty acids according to (1) or (2), wherein the organic acid is citric acid.
(4) A method of producing a grape juice-containing gummy containing polyunsaturated fatty acids according to the following processes:
1 a process of preparing a water phase in which a polyphenol and an organic acid are dissolved;
2 a process of preparing an oil phase containing polyunsaturated fatty acids;
3 a process of forming an oil and fat composition by finely dispersing the water phase of 1 with a particle diameter of 300 nm or less in the oil phase of 2; and
4 a process of dispersing the oil and fat composition of 3 in a grape juice-containing gummy.
(5) A method of reducing the occurrence of offensive odors in a grape juice-containing gummy containing polyunsaturated fatty acids obtained by forming an oil and fat composition in which a water phase with a particle diameter of 300 nm or less in which a polyphenol and an organic acid are dissolved is finely dispersed in an oil phase containing polyunsaturated fatty acids and dispersing the oil and fat composition in a grape juice-containing gummy.

### Advantageous Effects of Invention

According to the present invention, it is possible to reduce the occurrence of offensive odors in a grape juice-containing gummy containing polyunsaturated fatty acids.

### DESCRIPTION OF EMBODIMENTS

A gummy is a type of confectionery made by solidifying fruit juice or the like with gelatin. However, the presence of fruit juice is not clearly stipulated as definition of a gummy, and there may be gummies not containing fruit juice.

In the present invention, the gummy is defined as a confectionery made by solidifying fruit juice or the like with gelatin.

In the present invention, the water-soluble antioxidant refers to an antioxidant that dissolves in water. Specifically, ascorbic acid called vitamin C, its salts, and various polyphenols may be exemplified.

In the present invention, a polyphenol is used as a water-soluble antioxidant. Polyphenol is a general term for plant components having a plurality of phenolic hydroxy groups in the molecule and polyphenols are known to have an antioxidative effect. Specific examples of polyphenols as water-soluble antioxidants include catechin, anthocyanin, tannin, isoflavone, and chlorogenic acid. In addition, preparations in which one or more thereof are mixed can be used as polyphenols, and specific examples thereof include various extracts such as tea extracts, apple extracts, grape extracts, and grape seed extracts.

In the present invention, various plant extracts are also called polyphenols if they can be recognized as components containing a polyphenol as a main component, for example, if they are sold as polyphenol preparations or antioxidants containing a polyphenol as an active component. Here, the most preferable extract is a tea extract and this product contains catechin as a polyphenol as a main component.

In the present invention, a water phase in which a polyphenol is dissolved in water is used. The water phase is simply referred to as a water phase A.

The amount of polyphenols in the water phase A is preferably 30 to 60 mass %, more preferably 35 to 55 mass %, and still more preferably 40 to 50 mass %.

Here, the amount of polyphenols derived from the water phase A in the gummies with respect to the entire gummies is preferably 0.01 to 0.2 mass %, more preferably 0.015 to 0.1 mass %, and still more preferably 0.02 to 0.08 mass %.

When an appropriate amount of polyphenols as an appropriate water-soluble antioxidant is used, it is possible to reduce the occurrence of offensive odors in the gummy containing polyunsaturated fatty acids.

Here, the present invention reduces the occurrence of offensive odors derived from the polyunsaturated fatty acids in the grape juice-containing gummy containing polyunsaturated fatty acids. In addition, grape juice also contains polyphenols. However, in polyphenols derived from grape juice and directly contained in gummies, it is not possible to reduce the occurrence of offensive odors derived from polyunsaturated fatty acids. That is, as in the present invention, a polyphenol is dissolved in water to form a water phase (water phase A), the water phase A is finely dispersed in an oil phase containing polyunsaturated fatty acids to form an oil and fat composition, and thereby an effect of reducing the occurrence of offensive odors is obtained.

In the water phase A, it is necessary to dissolve an organic acid. Examples of organic acids include citric acid, malic acid, and tartaric acid, and citric acid is more preferable.

The amount of organic acids in the water phase A is preferably 5 to 25 mass %, more preferably 7 to 21 mass %, and still more preferably 11 to 19 mass %. In addition, the amount of organic acids derived in the water phase with respect to the entire gummies is preferably 0.001 to 0.1 mass %, more preferably 0.005 to 0.05 mass %, and still more preferably 0.007 to 0.02 mass %.

When an appropriate amount of an appropriate organic acid is contained in an appropriate manner, it is possible to reduce the occurrence of offensive odors in the gummy containing polyunsaturated fatty acids.

In the water phase A according to the present invention, in addition to polyphenols and organic acids, other water-soluble solid contents are preferably present. Examples of other water-soluble solid contents include carbohydrates and proteins, and carbohydrates are more preferable. Examples of carbohydrates include sucrose, glucose, and sugar alcohols, and sorbitol is more preferable.

The amount of the water-soluble solid content in the water phase A, including the amount of polyphenols and organic acids, is preferably 50 to 80 mass %, more preferably 60 to 80 mass %, and still more preferably 65 to 75 mass %.

When polyphenols and organic acids are dissolved in the water phase A and an appropriate amount of other water-soluble solid contents is appropriately dissolved, it is possible to reduce the occurrence of offensive odors in the gummy containing polyunsaturated fatty acids.

The present invention relates to a gummy containing polyunsaturated fatty acids. Polyunsaturated fatty acids have been assumed to have physiological effects in recent years, but their mode of intake is limited in some cases, and it is expected that they will be widely added to foodstuffs such as gummies that children can easily eat.

In the present invention, the polyunsaturated fatty acid is an unsaturated fatty acid having two or more unsaturated bonds, and more preferably DHA and/or EPA. DHA is an abbreviation for docosahexaenoic acid, and EPA is an abbreviation for eicosapentaenoic acid. In the present invention, incorporation of polyunsaturated fatty acids means incorporation of an oil and fat containing polyunsaturated fatty acids as one or more constituent fatty acids of triglycerides.

The amount of polyunsaturated fatty acids in the gummy according to the present invention is preferably 0.1 to 1.2 mass %, more preferably 0.2 to 1 mass %, and still more preferably 0.4 to 0.8 mass %. When an appropriate amount of polyunsaturated fatty acids is contained, it is possible to expect the physiological action accordingly, and it is possible to obtain gummies in which the occurrence of offensive odors is reduced.

In the present invention, the oil phase is a phase in which polyunsaturated fatty acids and other oil-soluble components are dissolved. Here, the oil phase according to the present invention is simply referred to as an oil phase A.

In general gummies, oils and fats are not essential components, but since the gummy of the present invention contains polyunsaturated fatty acids, an oil phase containing these polyunsaturated fatty acids is present.

In addition to polyunsaturated fatty acids, the oil-soluble components that can be contained in the oil phase A include an oil-soluble emulsifier. The oil-soluble emulsifier is an emulsifier with an HLB of less than 7, and has an effect of stabilizing the water-in-oil type emulsified state. Specifically, polyglycerin condensed ricinoleate, sucrose fatty acid ester, and glycerin fatty acid ester may be exemplified, and polyglycerin condensed ricinoleate is more preferable. In addition, although the HLB has a wide range, lecithin can also be used, and this is also contained in the oil-soluble emulsifier in the present invention. When an appropriate emulsifier is used, the water phase A containing a polyphenol can be easily finely dispersed in the oil phase, and strong antioxidative activity can be exhibited. As a result, in the grape juice-containing gummy containing polyunsaturated fatty acids, it is possible to reduce the occurrence of offensive odors.

In addition, in the oil phase A, oils and fats not containing polyunsaturated fatty acids can be used jointly. Specifically, vegetable fats such as soybean oil, rapeseed oil, rice oil, sesame oil, corn oil, palm oil, and cottonseed oil, and animal fats such as beef tallow and lard may be exemplified, and oils and fats obtained by performing one or more types of processing selected from among curing, fractionation, and transesterification on one or more selected from among the above components may be exemplified. In the present invention, one or more of these oils and fats can be selected and used.

Grape juice in the present invention is fruit juice extracted from grapes. Grape juice can be obtained by squeezing grapes and removing solids, and can be purchased commercially.

It is necessary to incorporate grape juice into the grape juice-containing gummy according to the present invention. In the present invention, in addition to preparing a gummy by adding grape juice after the start, a gummy containing grape juice can be directly used in the present invention. That is, a timing at which grape juice is added can be appropriately set.

The amount of grape juice in the grape juice-containing gummy can be appropriately set. In the first place, grape juice used for gummies is mostly concentrated grape juice, and it is difficult to strictly regulate the amount of grape juice. That is, even if the amount of grape juice is specified by the amount of concentrated grape juice, it may easily be outside of the specified range by adjusting the degree of concentration. On the other hand, even if the amount is specified based on the state before concentration, depending on the degree of concentration, the amount of grape juice in the gummy may exceed 100%, and may be imprecise for determining the composition.

In the present invention, the amount of grape juice in the grape juice-containing gummy generally refers to about the content that is commercially available in the “grape juice-containing gummy.” Here, some grape juice-containing gummies may contain 100% of fruit juice because concentrated grape juice is used.

Next, a method of producing gummies according to the present invention will be described with examples.

First, according to the formulation, a water phase (water phase A) in which a water-soluble antioxidant and an organic acid are dissolved is prepared. Next, according to the formulation, an oil phase containing polyunsaturated fatty acids (oil phase A) is prepared. Here, when there is no oil phase component other than the oils and fats containing polyunsaturated fatty acids, the polyunsaturated fatty acid-containing oil and fat itself has the same meaning as the oil phase A.

Next, the water phase A is added to the oil phase A and finely dispersed so that the particle diameter of the water phase A is 300 nm or less to obtain a water-in-oil type oil and fat composition. The water-in-oil type oil and fat composition is referred to as an oil and fat composition A.

Various devices can be used for such emulsification, and specific examples thereof include a high pressure homogenizer and an ultrasonic emulsifier. When an appropriate emulsification device is used, it is possible to reduce the occurrence of unusual flavors in the gummy. Here, when a high pressure homogenizer is used, general emulsification conditions are 30 to 40 MPa, and 10 to 30 passes.

Next, the oil and fat composition A is dispersed in the gummy. Here, in the simplest manner, a commercially available grape juice-containing gummy is melted by heating, and the oil and fat composition A is added thereto and stirred. Then, the mixture is poured into an appropriate mold and solidified for completion.

Here, in the oil and fat composition A, since the average particle diameter of the water phase is 300 nm or less, even if the water phase is dispersed in the gummy, it can be said that the water phase with a particle diameter of 300 nm or less is present in the gummy.

In the water-in-oil type oil and fat composition (oil and fat composition A), the method of measuring the water phase particle diameter is as follows.
Device name: Zetasizer Nano S, manufacturer: Malvern, 10 μl of an oil and fat composition to be measured was diluted with 2 ml of hexane and measured (in measurement at the stage of the first day after sample preparation, if the particle diameter exceeds 300 nm (that is, if precipitation occurs), it is unsatisfactory)
Temperature: 20.0° C.
Equilibrium time: 240 seconds
Cell: glass cell
Measurement angle: 173°
Positioning method: optimal position selection
Selection of automatic damping: yes

Hereinafter, embodiments of the invention will be described in more detail with reference to examples.

### EXAMPLES

### Examination 1 Preparation of Oil and Fat Composition Containing Polyunsaturated Fatty Acids

According to the formulation in Table 1-1, an oil and fat composition containing polyunsaturated fatty acids was prepared. The preparation method was “○ Method of preparing an oil and fat composition containing polyunsaturated fatty acids.”

TABLE 1-1
Formulation of oil and fat composition
containing polyunsaturated fatty acids

| | | Examination | Examination |
|---|---|---|---|
| | | 1-1 | 1-2 |
| Water phase | Ascorbic acid | 0.45% | — |
| | Sodium ascorbate | 0.74% | — |
| | Polyphenol 1 | — | 1.64% |
| | Sorbitol | — | 0.62% |
| | Citric acid | — | 0.45% |
| | Water | 1.19% | 1.19% |
| Oil phase | Emulsifier | 1.49% | 1.34% |
| | Soybean oil | 11.00% | 9.63% |
| | PUFA oil | 85.13% | 85.13% |

| | | |
|---|---|---|
| Total | 100.00% | 100.00% |
| Concentration of water-soluble | 50.1% | 42.1% |
| antioxidant in water phase (mass %) | | |
| Concentration of water-soluble | 50.1% | 69.5% |
| solid content in water phase (mass %) | | |
| Concentration of organic acid | | 11.4% |
| in water phase (mass %) | | |

(unit in formulation is mass %)
For polyphenol 1, “Sunphenon 90S” (tea extract, commercially available from Taiyo Kagaku Co., Ltd.) was used. This product contained a large amount of catechin, which is a polyphenol.
For sorbitol, “Sorbitol FP” (commercially available from B Food Science Co., Ltd.) was used.
For the emulsifier, polyglycerin condensed ricinoleic acid ester “CRS-75” (commercially available from Sakamoto Yakuhin Kogyo Co., Ltd.) was used.
The PUFA oil was an oil and fat containing polyunsaturated fatty acids, and an oil and fat containing a total amount of 32.6 mass % of DHA and EPA was used for this.
All the particle diameters of the water phase were 300 nm or less.

### ○ Method of Preparing an Oil and Fat Composition Containing Polyunsaturated Fatty Acids

1. In the formulation, the water phase was prepared by mixing those classified as the water phase.

2. In the formulation, an oil phase was prepared by mixing those classified as the oil phase.

3. While the oil phase was stirred, the water phase was gradually added to obtain a water-in-oil type approximate emulsion.

4. Using a high pressure homogenizer, emulsification was performed in a water-in-oil type emulsion at 37 Mpa and 20 passes to obtain an “oil and fat composition containing polyunsaturated fatty acids.”

### Examination 2 Preparation of Gummy and Storage Test

According to the formulation in Table 2-1, gummies were prepared. The preparation method was “○ Gummy preparation method.”

A storage test was performed on the obtained gummies. The method was “○ Gummy storage test method.” The results are shown in Table 2-2.

TABLE 2-1
Formulation of gummies

| | Compar- | Compar- | Compar- | |
|---|---|---|---|---|
| | ative | ative | ative | |
| | Example | Example | Example | Example |
| | 2-1 | 2-2 | 2-3 | 2-1 |
| Gummy 1 | 87.74 | 87.74 | — | — |
| Gummy 2 | — | — | 87.74 | 87.74 |
| Emulsifier | 0.10 | 0.10 | 0.10 | 0.10 |
| Water | 10.00 | 10.00 | 10.00 | 10.00 |
| Oil and fat | 2.16 | — | 2.16 | — |
| composition | | | | |
| containing | | | | |
| polyunsaturated | | | | |
| fatty acids | | | | |
| obtained in | | | | |
| Examination | | | | |
| 1-1 | | | | |
| Oil and fat | — | 2.16 | — | 2.16 |
| composition | | | | |
| containing | | | | |
| polyunsaturated | | | | |
| fatty acids | | | | |
| obtained in | | | | |
| Examination | | | | |
| 1-2 | | | | |
| Total | 100.00 | 100.00 | 100.00 | 100.00 |
| Total amount of | 0.60 | 0.60 | 0.60 | 0.60 |
| DHA and EPA | | | | |
| (mass %) | | | | |
| Amount of | — | 0.04 | — | 0.04 |
| polyphenol | | | | |
| derived from | | | | |
| water phase in | | | | |
| gummy | | | | |
| (mass %) | | | | |
| Amount of | — | 0.01 | — | 0.01 |
| organic acid | | | | |
| derived from | | | | |
| water phase in | | | | |
| gummy | | | | |
| (mass %) | | | | |

(unit in formulation is mass %)
For gummy1, fruit juice gummy “Satsuma mandarin” (commercially available from Meiji Co., Ltd.) was used. This product was described as Satsuma mandarin juice 100 (fresh fruit juice conversion ratio). In the raw material list, “concentrated mandarin juice” is listed after starch syrup and sugar.
For gummy 2, fruit juice gummy “Grape” (commercially available from Meiji Co., Ltd.) was used. This product was described as grape juice 100 (fresh fruit juice conversion ratio). In the raw material list, “concentrated grape juic” is listed after starch syrup and sugar.
For the emulsifier, polyglyceryl monolaurate “SY Glyster ML-750” (commercially available from Sakamoto Yakuhin Kogyo Co., Ltd.) was used.

### ○ Gummy Preparation Method

1 According to the formulation table, gummies, water, and emulsifiers were heated and melted in a microwave oven.

2 The oil and fat compositions containing polyunsaturated fatty acids obtained in Examination 1-1 and Examination 1-2 were added and stirred and made uniform.

3 In a hot water bath at 90° C., the sample was stirred at 200 rpm for 1 hour.

4 10 ml of the sample was dispensed into a silicone cup having an opening diameter of 4 cm and cooled at room temperature.

### ○ Gummy Storage Test Method

1. The six gummies prepared according to “0 Gummy preparation method” were put into a 200 ml plastic container with a lid, and placed in an incubator at 30° C. and left. Here, the inside of the incubator was light-blocked.

2. Every month, four panelists checked odors, and scored based on the following criteria according to consultation.
1 point Felt fish smell strongly
2 points Felt fish smell slightly
3 points Dull flavor, but within an acceptable range.
4 points The flavor was slightly dull.
5 points The flavor was almost the same as when the sample was prepared.

In the evaluation after storage at 30° C. for 2 months, four or more points were determined to be satisfactory.

TABLE 2-2
Results

| | Comparative | Comparative | Comparative | |
|---|---|---|---|---|
| | Example 2-1 | Example 2-2 | Example 2-3 | Example 2-1 |
| First month | 4 | 4 | 3 | 5 |
| Second | 4 | 3 | 3 | 4 |
| month | | | | |

### Conclusions

Comparative Example 2-1 contained Satsuma mandarin juice, but it was possible to reduce the occurrence of offensive odors even after 2 months with ascorbic acid (vitamin C), which is generally used as an antioxidant.

Comparative Example 2-3 contained grape juice, but unlike Comparative Example 2-1, it was not possible to sufficiently reduce the occurrence of offensive odors with ascorbic acid. Accordingly, the gummy containing grape juice itself was not thought to have antioxidative activity.

Although Example 2-1 contained grape juice, it was confirmed that, when a polyphenol (here, a tea extract; the active component was catechin) was used as an antioxidant, it was possible to effectively reduce the occurrence of offensive odors.

Comparative Example 2-2 contained Satsuma mandarin juice, but, in response to Example 2-1, and a test was performed using a polyphenol as an antioxidant, but an effect of reducing the occurrence of offensive odors was limited.

As above, it was clarified that, depending on the fruit juice used in the gummy, there was a difference in antioxidants for reducing the occurrence of offensive odors when DHA or EPA was contained, and in the grape juice-containing gummy, it was possible to effectively reduce the occurrence of offensive odors with the polyphenol.

### Examination 3 Preparation of Gummies and Storage Test

Using the oil and fat composition containing polyunsaturated fatty acids prepared in Examination 1, gummies were prepared according to Table 3-1. The preparation method was “○ Gummy preparation method.”

A storage test was performed on the obtained gummies. The method was “○ Gummy storage test method.” The results are shown in Table 3-2.

TABLE 3-1
Formulation

| | Comparative | | Comparative | | Comparative |
|---|---|---|---|---|---|
| | Example | Example | Example | Example | Example |
| | 3-1 | 3-1 | 3-2 | 3-2 | 3-3 |
| Gummy 1 | 87.74 | 87.74 | — | — | — |
| Gummy 2 | — | — | 87.74 | 87.74 | — |
| Gummy 3 | — | — | — | — | 87.74 |
| Emulsifier | 0.1 | 0.1 | 0.1 | 0.1 | 0.1 |
| Water | 10 | 10 | 10 | 10 | 10 |
| Oil and fat | 2.16 | — | 2.16 | — | — |
| composition | | | | | |
| containing | | | | | |
| polyunsaturated | | | | | |
| fatty acids obtained | | | | | |
| in Examination 1-1 | | | | | |
| Oil and fat | — | 2.16 | — | 2.16 | 2.16 |
| composition | | | | | |
| containing | | | | | |
| polyunsaturated | | | | | |
| fatty acids obtained | | | | | |
| in Examination 1-2 | | | | | |
| Total | 100 | 100 | 100 | 100 | 100 |
| Total amount of | 0.6 | 0.6 | 0.6 | 0.6 | 0.6 |
| DHA and EPA | | | | | |
| (mass%) | | | | | |
| Amount of | — | 0.04 | — | 0.04 | 0.04 |
| polyphenol derived | | | | | |
| from water phase | | | | | |
| in gummy (mass %) | | | | | |
| Amount of organic | — | 0.01 | — | 0.01 | 0.01 |
| acid derived from | | | | | |
| water phase in | | | | | |
| gummy (mass %) | | | | | |

(unit in formulation is mass %)“”
For gummy 1, gummy “Fettuccine gummi” (grape) (commercially available from Bourbon Corporation) was use. In the raw material list of this product, “concentrated grape juice” is listed after sugar and starch syrup.
For gummy 2, gummy “Pure gummy” (grape) (commercially available from Kanro Inc.) was used. In the raw material list of this product, “concentrated grape juice” is listed after sugar, starch syrup, and gelatin.
For gummy 3, among “Chigumi” gummies, (commercially available from Kabaya Foods Corporation) a gummy colored “grape” was used. In the raw material list of this product, grape juice was not listed.
For the emulsifier, polyglyceryl monolaurate “SY Glyster ML-750” (commercially available from Sakamoto Yakuhin Kogyo Co., Ltd.) was used.

TABLE 3-2
Results

| | Compar- | | Compar- | | Compar- |
|---|---|---|---|---|---|
| | ative | | ative | | ative |
| | Example | Example | Example | Example | Example |
| | 3-1 | 3-1 | 3-2 | 3-2 | 3-3 |
| Second | 3 | 4 | 3 | 5 | 3 |
| month | | | | | |

### Conclusions

It was confirmed that, in the grape juice-containing gummies among respective manufacturers, when a polyphenol was used as an antioxidant, it was possible to further reduce the occurrence of unusual flavors than when vitamin C was used.

In Comparative Example 3-3, the gummy (gummy 3) which was assumed to have no grape juice and probably have grape flavor added was used, but even if a polyphenol was used as an antioxidant, it was not possible to reduce the occurrence of unusual flavors.

### Examination 4 Preparation of Oil and Fat Composition Containing Polyunsaturated Fatty Acids 2

According to the formulation in Table 4-1, an oil and fat composition containing polyunsaturated fatty acids was prepared. The preparation method was “○ Method of preparing an oil and fat composition containing polyunsaturated fatty acids.”

TABLE 4-1
Formulation of oil and fat composition
containing polyunsaturated fatty acids

| | | Exam- | Exam- | Exam- | Exam- |
|---|---|---|---|---|---|
| | | ination | ination | ination | ination |
| | | 4-1 | 4-2 | 4-3 | 4-4 |
| Water phase | Ascorbic acid | 0.45 | — | — | — |
| | Sodium | 0.75 | — | — | — |
| | ascorbate | | | | |
| | Polyphenol 1 | — | 1.20 | — | — |
| | Polyphenol 2 | — | — | 1.65 | — |
| | Polyphenol 3 | — | — | — | 1.65 |
| | Citric acid | 0.47 | — | 0.63 | 0.63 |
| | Sorbitol | 0.33 | — | 0.45 | 0.45 |
| | Water | 0.87 | 1.20 | 1.20 | 1.20 |
| Oil phase | Emulsifier | 0.98 | 1.50 | 1.35 | 1.35 |
| | Soybean oil | 11.15 | 11.10 | 9.72 | 9.72 |
| | PUFA oil | 85.00 | 85.00 | 85.00 | 85.00 |

| | | | | |
|---|---|---|---|---|
| Total | 100.00 | 100.00 | 100.00 | 100.00 |
| Concentration of | 41.88 | 50.00 | 41.98 | 41.98 |
| water-soluble antioxidant in | | | | |
| water phase (mass %) | | | | |
| Concentration of | 69.63 | 50.00 | 69.47 | 69.47 |
| water-soluble solid content in | | | | |
| water phase (mass %) | | | | |
| Concentration of organic acid | 16.23 | — | 16.03 | 16.03 |
| in water phase (mass %) | | | | |
| Average particle diameter of | 152.3 | 134.8 | 153.7 | 138.4 |
| water phase (nm) | | | | |

(unit in formulation is mass %)
For polyphenol 1, tea extract “Sunphenon 90S” (commercially available from Taiyo Kagaku Co., Ltd.) was used. This product contained a large amount of catechin.
For polyphenol 2, apple extract polyphenol “Applephenon SH” (commercially available from Asahi Food & Healthcare, Ltd.) was used.
For polyphenol 3, grape seed extract polyphenol “Grape seed extract FJ” (commercially available from Sabinsa Japan Corporation) was used.
For sorbitol, “Sorbitol FP” (commercially available from B Food Science Co., Ltd.) was used.
For the emulsifier, polyglycerin condensed ricinoleic acid ester “CRS-75” (commercially available from Sakamoto Yakuhin Kogyo Co., Ltd.) was used.
The PUFA oil was an oil and fat containing polyunsaturated fatty acids, and an oil and fat containing a total amount of 32.6 mass % of DHA and EPA was used for this.

### Examination 5 Preparation of Gummies and Storage Test 2

According to the formulation in Table 5-1, gummies were prepared. The preparation method was “0 Gummy preparation method.”

A storage test was performed on the obtained gummies. The method was “○ Gummy storage test method.” The results are shown in Table 5-2.

TABLE 5-1
Formulation of gummies

| | Compar- | Compar- | | |
|---|---|---|---|---|
| | ative | ative | | |
| | Example | Example | Example | Example |
| | 5-1 | 5-2 | 5-1 | 5-2 |
| Gummy 1 | 87.74 | 87.74 | 87.74 | 87.74 |
| Emulsifier | 0.10 | 0.10 | 0.10 | 0.10 |
| Water | 10.00 | 10.00 | 10.00 | 10.00 |
| Oil and fat | 2.16 | — | — | — |
| composition | | | | |
| containing | | | | |
| polyunsaturated | | | | |
| fatty acids obtained | | | | |
| in Examination 4-1 | | | | |
| Oil and fat | — | 2.16 | — | — |
| composition | | | | |
| containing | | | | |
| polyunsaturated | | | | |
| fatty acids obtained | | | | |
| in Examination 4-2 | | | | |
| Oil and fat | — | — | 2.16 | — |
| composition | | | | |
| containing | | | | |
| polyunsaturated | | | | |
| fatty acids obtained | | | | |
| in Examination 4-3 | | | | |
| Oil and fat | — | — | — | 2.16 |
| composition | | | | |
| containing | | | | |
| polyunsaturated | | | | |
| fatty acids obtained | | | | |
| in Examination 4-4 | | | | |
| Total | 100.00 | 100.00 | 100.00 | 100.00 |
| Total amount of | 0.60 | 0.60 | 0.60 | 0.60 |
| DHA and EPA | | | | |
| (mass %) | | | | |
| Amount of | — | 0.03 | 0.03 | 0.03 |
| polyphenol derived | | | | |
| from water phase in | | | | |
| gummy (mass %) | | | | |
| Amount of organic | 0.01 | — | 0.01 | 0.01 |
| acid derived from | | | | |
| water phase in | | | | |
| gummy (mass %) | | | | |

(unit in formulation is mass %)
For gummy 1, fruit juice gummy “Grape” (commercially available from Meiji Co., Ltd.) was used. This product was described as grape juice 100 (fresh fruit juice conversion ratio). In the raw material list, “concentrated grape juice” is listed after starch syrup and sugar.
For the emulsifier, polyglyceryl monolaurate “SY Glyster ML-750” (commercially available from Sakamoto Yakuhin Kogyo Co., Ltd.) was used.

TABLE 5-2
Results

| | Compar- | Compar- | | |
|---|---|---|---|---|
| | ative | ative | | |
| | Example | Example | Example | Example |
| | 5-1 | 5-2 | 5-1 | 5-2 |
| First month | 4 | 2 | 4 | 4 |
| Second month | 3 | 1 | 4 | 4 |

### Conclusions

As shown in Examples 5-1 and 5-2, even if various polyphenols were used, it was possible to reduce the occurrence of unusual flavors in the grape juice-containing gummy.

In Comparative Example 5-1, even if citric acid was used in combination with vitamin C, it was not possible to sufficiently reduce the occurrence of unusual flavors in the grape juice-containing gummy. That is, it was confirmed that organic acids such as citric acid exhibited no effect even when used in combination with vitamin C, and the effect was exhibited only when used in combination with polyphenols.

In Comparative Example 5-2, the polyphenol was used as an antioxidant, but without use of citric acid in combination, a flavor improving effect in the grape juice-containing gummy was not observed.

1. A grape juice-containing gummy containing polyunsaturated fatty acids obtained by forming an oil and fat composition in which a water phase with a particle diameter of 300 nm or less in which a polyphenol and an organic acid are dissolved is finely dispersed in an oil phase containing polyunsaturated fatty acids and dispersing the oil and fat composition in a gummy containing grape juice.

2. The grape juice-containing gummy containing polyunsaturated fatty acids according to claim 1,
wherein the amount of the polyunsaturated fatty acids in the gummy is 0.1 to 1.2 mass %.

3. The grape juice-containing gummy containing polyunsaturated fatty acids according to claim 1,
wherein the organic acid is citric acid.

4. A method of producing a grape juice-containing gummy containing polyunsaturated fatty acids according to the following processes:
1 a process of preparing a water phase in which a polyphenol and an organic acid are dissolved;
2 a process of preparing an oil phase containing polyunsaturated fatty acids;
3 a process of forming an oil and fat composition by finely dispersing the water phase of 1 with a particle diameter of 300 nm or less in the oil phase of 2; and
4 a process of dispersing the oil and fat composition of 3 in a grape juice-containing gummy.

5. A method of reducing the occurrence of offensive odors in a grape juice-containing gummy containing polyunsaturated fatty acids obtained by forming an oil and fat composition in which a water phase with a particle diameter of 300 nm or less in which a polyphenol and an organic acid are dissolved is finely dispersed in an oil phase containing polyunsaturated fatty acids and dispersing the oil and fat composition in a grape juice-containing gummy.

6. The grape juice-containing gummy containing polyunsaturated fatty acids according to claim 2,
wherein the organic acid is citric acid.
